(19) United States
(12) Patent Application Publication
(10) Pub. No.: US 2007/0164078 A1
(43) Pub. Date: Jul. 19, 2007

(54) Spin welding device

(75) Inventor: Erwin Bayer, Dachau (DE)

Correspondence Address: DAVIDSON, DAVIDSON & KAPPEL, LLC, 485 SEVENTH AVENUE, 14TH FLOOR, NEW YORK, NY, 10018, US

(73) Assignee: MTU Aero Engines GmbH, Muenchen (DE)

(21) Appl. No.: 10/585,268

(22) PCT Filed: Dec. 16, 2004
(86) PCT No.: PCT/DE04/02750

§ 371 Date: Jul. 5, 2006

(30) Foreign Application Priority Data
Jan. 8, 2004 (DE) 10 2004 001 274.1

(51) Int. Cl. A47J 36/02

(52) U.S. Cl. 228/101

(57) ABSTRACT

A rotary friction welding system is provided comprising a first rotary spindle (14) and a second dead spindle (15), wherein the first spindle (14) carries a first mutually connectable component (11) and the second spindle (15) carries a second mutually connectable component (12). The rotary friction welding system also comprises a positioning device (25) for orienting the component (12) arranged on the second spindle (15) with respect to the component (11) arranged on the first rotary spindle (14) and a contact force device (26) for providing a spin welding with the required contact force. The positioning device (25) and contact force device (26) are coupled to each other in such a way that the component (12) arranged on the second spindle (15) is orientable with respect to the component (11) arranged on the first rotary spindle (14) before and/or during the spin welding process.

The present invention relates to a rotary friction welding system according to the definition of the species in Patent claim 1.

Friction welding is a widespread joining process in the manufacture of gas turbines. Friction welding is one of the pressure welding methods; in friction welding one distinguishes what is known as linear friction welding from rotary friction welding and friction stir welding. The present invention relates to what is known as rotary friction welding in which rotationally symmetric components are welded together via external friction. During the rotary friction welding process, a first component rotates, whereas the other component is stationary and is pressed with a certain force against the rotary component. The force exerted here is also referred to as friction force. Joining surfaces of the components to be joined together adapt to one another by becoming pasty. The energy inherent in flywheels is absorbed by friction; the rotary component is decelerated and increased force, known as contact force, is applied in order to compress the two components in the area of the weld.

Rotary friction welding is carried out on rotary friction welding systems where, according to the related art, the rotary component is mounted on a rotating spindle and the stationary component is mounted on a non-rotating spindle. It is important in rotary friction welding to position the components to be welded together exactly with respect to each other and to provide the contact force exactly to the required extent. For this purpose, rotary friction welding systems have a positioning device, for adjusting the component mounted on the non-rotating spindle relative to the component mounted on the rotating spindle, and a contact force device in order to provide the required contact force.

According to the related art, alignment of the stationary side and the rotating side of a rotary friction welding system takes place using keys. Alignment with the aid of keys may only be carried out with great complexity and does not allow alignment of the components to be welded together during the welding process. In the rotary friction welding systems known from the related art, adjustment of the components to be welded together is thus only possible to a very limited extent. The contact force required for rotary friction welding is hydraulically generated in rotary friction welding systems according to the related art. A hydraulic contact force device has the disadvantage that accurate control of the provided contact force is not possible. Therefore, according to the related art, a separate rotary friction welding system must be built for each contact force class.

Based on this fact, the object of the present invention is to create a novel rotary friction welding system.

This object is achieved in that the above-mentioned rotary friction welding system is refined by the features of the characterizing portion of Patent claim 1. According to the present invention, the positioning device and the contact force device are preferably connected via a parallel kinematic device in such a way that the component mounted on the second non-rotating spindle is alignable three-dimensionally in space relative to the component mounted on the first rotating spindle prior to and/or during the rotary friction welding process. Using the rotary friction welding system according to the present invention, a dynamic alignment of the two components to be joined together may be carried out prior to and during the rotary friction welding process. This makes it possible to substantially improve the quality of the welded joint. The contact force device may be integrated into the parallel kinematic device or it may be designed as a separate unit.

According to an advantageous refinement of the present invention, a measuring device monitors the adjustment of the component mounted on the non-rotating spindle relative to the component mounted on the rotating spindle, the adjustment of the component mounted on the non-rotating spindle relative to the component mounted on the rotating spindle being controllable prior to and during the rotary friction welding process as a function of a measuring signal provided by the measuring device.

The contact force device for providing the contact force required for rotary friction welding is preferably designed as a position-controlled and/or force-controlled piezoelectric drive or as a combination of a hydraulic drive with a piezoelectric fine regulation. By using a piezoelectric contact force device, the required contact force may be provided in a wider range and more accurately compared to the purely hydraulic contact force devices known from the related art. It is thus possible to create a rotary friction welding system which is suitable for multiple contact force classes.

Preferred refinements of the present invention arise from the subclaims and the following description. Exemplary embodiments are explained in greater detail on the basis of the drawing, without being restricted thereto.

FIG. 1 shows a schematic representation of a rotary friction welding system according to the related art;

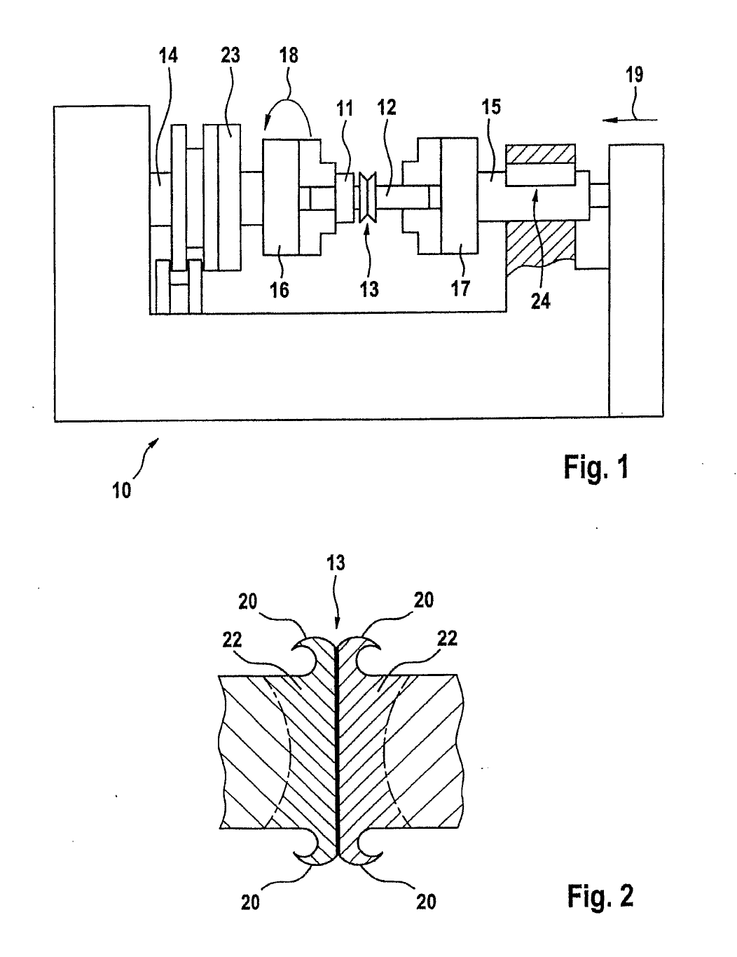

FIG. 2 shows a rotary friction weld between two components joined together, and

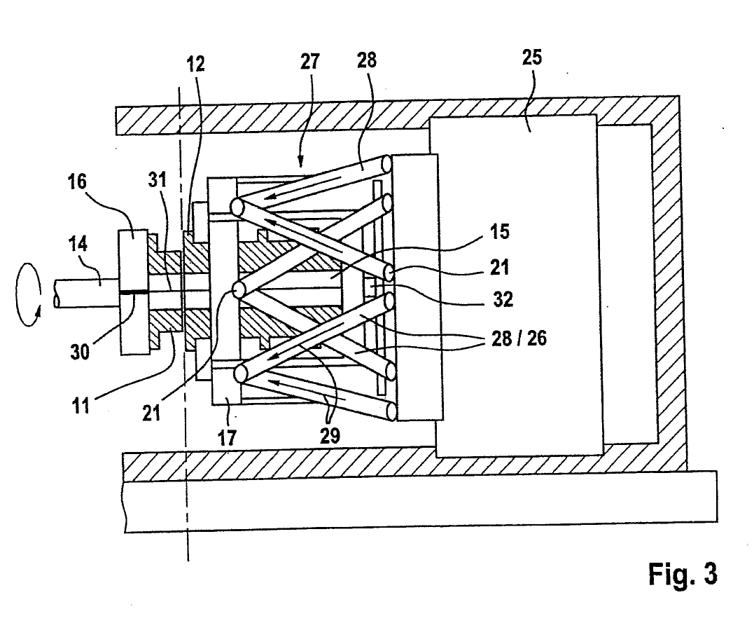

FIG. 3 shows a schematic detail of a rotary friction welding system according to the present invention.

FIG. 1 shows a rotary friction welding system 10 for joining two components 11 and 12 according to the related art, weld 13, shown enlarged in FIG. 2, being formed between components 11 and 12 during the rotary friction welding process. Rotary friction welding system 10 according to the related art shown in FIG. 1 has a first rotating spindle 14 and a second non-rotating spindle 15. Of components 11 and 12 to be joined together, component 11 is situated or mounted on first rotating spindle 14 and component 12 is situated or mounted on the second non-rotating spindle. For this purpose, clamping devices 16 and 17 are assigned to spindles 14 and mountable on the particular spindles 14 and 15. A flywheel 23 is assigned to the first rotating 15. Using clamping devices 16 and 17, components 11 and 12 to be joined together are spindle.

In order to join both components 11 and 12 together using rotary friction welding, component 11 mounted on first rotating spindle 14 is rotary as defined by arrow 18, component 12 mounted on second non-rotating spindle 15 being pressed against component 11 using friction force as defined by arrow 19. The relative rotation between components 11 and 12, as well as the friction force, generate friction and thus heating of both components 11 and 12 on their welding surfaces, thereby forming a welding bead 20. In the process, the material of components 11 and 12 becomes pasty on the welding surfaces. The energy stored in flywheel 23 is expended via friction. First rotating spindle 14 and thus component 11 assigned to same are decelerated and, at the same time, component 12 is pressed with increased force, known as contact force, onto component 11. An area 22, highly heated due to the heating process, between components 11 and 12 cools down and weld 13 is finally formed.

In rotary friction welding system 10 according to the related art shown in FIG. 1, the mechanical adjustment of the two components 11 and 12 to be welded together and thus the rotating side is adjusted with respect to the non-rotating side of the rotary friction welding system 10 via keys 24 which are assigned to non-rotating spindle 15. Use of such keys 24 for adjusting the components to be joined together requires great complexity and is only possible prior to the rotary friction welding process.

FIG. 3 shows a detail of a rotary friction welding system according to the present invention, the rotating side of the rotary friction welding system and the non-rotating side of same being separated from one another in FIG. 3 for the sake of clarity by a vertical dash-and-dotted line. FIG. 3 shows component 11 assigned to rotating spindle 14 and component 12 assigned to non-rotating spindle 15 in cross section, both components 11 and 12 being mounted on the particular spindles 14 and 15 via clamping devices 16 and 17.

A positioning device 25 is assigned to the non-rotating side of the rotary friction welding system according to FIG. 3 to align component 12 mounted on the non-rotating spindle relative to component 11 mounted on the rotating spindle 14. Furthermore, a contact force device 26 is assigned to the non-rotating side of the rotary friction welding system according to FIG. 3 in order to generate the contact force required for rotary friction welding. According to the present invention, positioning device 25 and contact force device 26 are coupled together via a parallel kinematic device 27. Using a parallel kinematic device 27, component 12 mounted on the non-rotating spindle 15 is three-dimensionally alignable in space relative to component 11 mounted on first spindle 14. Components 11 and 12 to be joined together may therefore be exactly aligned in such a way that the opposite front surfaces to be welded together are aligned in parallel to the two components 11 and 12 and, in this parallel alignment, an axial offset of components 11 and 12 is avoided. Parallel kinematic device 27 allows a five-axis or even a six-axis movement of component 12 mounted on the second, non-rotating spindle 15. Parallel kinematic device 27 is preferably designed as a hexapod, braces 28 of hexapod 27 being designed as being variable in length. As defined by arrows 29, each brace 28 variable in length of hexapod 27 may be adjusted by itself independently from the other braces 28. This makes the five-axis or six-axis movement of component 12 relative to component 11 possible. Contact force device 26 may integrated into a parallel kinematic device 27 so that the parallel kinematic device provides the required contact force.

Using the above-described parallel kinematic device, both components 11 and 12 to be welded together may be exactly aligned prior to and during the rotary friction welding process. The rotary friction welding system according to the present invention thus enables a dynamic adjustment of components 11 and 12 to be joined together. A measuring device 30 is provided for dynamic adjustment during the rotary friction welding process. In the exemplary embodiment of FIG. 3, measuring device 30 is designed as a laser source which is situated in the center of the rotary axis of spindle 14 or clamping device 16, a point of incidence 32 of laser beam 31 emitted from laser source 30 on non-rotating component 12 being monitored. A measuring signal, dependent thereof, is then used for regulating the alignment of components 11 and 12 to be joined together. In the exemplary embodiment shown, laser source 30 is assigned to the rotating side of the rotary friction welding system. It should be pointed out here that laser source 30 may also be assigned to the non-rotating side, in this case a point of incidence of the laser beam of the laser source on rotating component 11 being monitored and analyzed.

Using the parallel kinematic device for connecting positioning device 25 and contact force device 26, it is possible to align both components 11 and 12 to be joined together so that their center axes are exactly aligned to each other during the entire rotary friction welding process. A dynamic post-adjustment during the rotary friction welding process is thus possible. The individual braces 28 of parallel kinematic device 27, designed as a hexapod, are staggered with respect to each other and are able to absorb the entire torque acting during the rotary friction welding process. The entire arrangement is very rigid since braces 28 are preferably mounted via solid joints 21.

According to an advantageous refinement of the present invention, contact force device 26 for providing the required contact force and the required contact path is designed as a piezoelectric drive. The piezoelectric drive may be position-controlled and/or force-controlled. The measuring signal of the above-described measuring device 30 may be used for position-controlling the piezoelectric drive. If, in addition, a force control of the piezoelectric drive is to be made possible, it is within the scope of the present invention to assign a load cell to the piezoelectric drive using which the contact force generated during rotary friction welding may be detected online and analyzed. The measuring signal provided by the load cell may then be used for force control of the piezoelectrically designed contact force device. Using piezoelectric drives makes it possible to provide contact forces of a few thousand kN in a controlled manner. Moreover, the contact path may be predefined very accurately. In contrast to the hydraulic contact force devices known from the related art, it is thus possible to apply the contact force in a more controlled manner.

According to the present invention, it is also possible to design contact force device 26 as a combination of a hydraulic or mechanical drive and a piezoelectric drive. The hydraulic or mechanical drive is then used for rough positioning and the piezoelectric drive for rapid fine positioning. If the positioning accuracy required from contact force device 26 is low, a purely hydraulic drive or a recirculating ball screw may also be used for position control and contact force generation.

1-11. (canceled)

12. A rotary friction welding system for joining two components, comprising
a first rotating spindle and a second non-rotating spindle, a first component of the two components to be joined together being mounted on the first spindle and a second component of the two components to be joined together being mounted on the second spindle;
a positioning device mounted on the first rotating spindle, the positioning device aligning the second component relative to the first component; and
a contact force device, the contact force device providing the contact force required for rotary friction welding;
wherein the positioning device and the contact force device are connected to one another such that the second component is alignable three-dimensionally in space relative to the first component prior to and/or during a rotary friction welding process.

13. The rotary friction welding system as recited in claim 12,
wherein the positioning device and the contact force device are connected to one another via a parallel kinematic device.

14. The rotary friction welding system as recited in claim 13, wherein a five-axis or six-axis movement of the second component is executable using the parallel kinematic device.

15. The rotary friction welding system as recited in claim 13, wherein the parallel kinematic device comprises a hexapod.

16. The rotary friction welding system as recited in claim 12, further comprising a measuring device, the measuring device monitoring the alignment of the second component relative to the first component.

17. The rotary friction welding system as recited in claim 16, wherein the alignment of the second component relative to the first component is controllable prior to and during the rotary friction welding process as a function of a measuring signal from the measuring device.

18. The rotary friction welding system as recited in claim 16, wherein the measuring device comprises a laser, a point of incidence of a laser beam emitted by the laser on one of the first and second components being monitored.

19. The rotary friction welding system as recited in claim 12, wherein the contact force device comprises a piezoelectric drive.

20. The rotary friction welding system as recited in claim 12, wherein the contact force device comprises a combination of a hydraulic or mechanical drive for rough positioning and a piezoelectric drive for fine positioning.

21. The rotary friction welding system as recited in claim 19, wherein the piezoelectric drive is position-controlled and/or force-controlled.

22. The rotary friction welding system as recited in claim 13, wherein the contact force device is integrated into the parallel kinematic device.
